(19) United States
(12) Patent Application Publication
(10) Pub. No.: US 2011/0098098 A1
(43) Pub. Date: Apr. 28, 2011

(54) MULTIPLE SIMULTANEOUS SYMBOLS

(75) Inventors: Scott Stewart, Las Vegas, NV (US); Casey Condron, Las Vegas, NV (US)

(73) Assignee: Aristocrat Technologies Australia PTY Limited, North Ryde (AU)

(21) Appl. No.: 12/606,881

(22) Filed: Oct. 27, 2009

(51) Int. Cl. A63F 9/24; A63F 13/00

(52) U.S. Cl. 463/20; 463/30

(57) ABSTRACT

An example method of gaming includes determining a presence of a multiple element symbol in a player combination of symbols to be generated and displayed to a player at a gaming display. The method also includes randomly generating a first element of the multiple element symbol. The method further includes randomly generating a second element of the multiple element symbol, wherein the second element is different from the first element. Additionally, the method includes determining one or more game outcomes in the player combination of symbols, wherein each element of the multiple element symbol is evaluated for contribution to a winning pattern in the player combination of symbols enabling a plurality of different winning patterns including the multiple element symbol. The method includes outputting the player combination of symbols and an indication of the one or more game outcomes to the gaming display for player view.

### FIELD

The present invention relates to a gaming system, a method of gaming, a game controller, and computer program code.

### BACKGROUND

In the casino industry, gaming machines, such as slot machines, fruit machines, or poker machines, have in recent years become one of the more popular, exciting, and sophisticated wagering activities available at casinos and other gambling locations. At the same time, gaming machines have also become a source of greater revenue for gaming establishments.

A gaming system such as a video slot machine can include symbols displayed as a plurality of virtual reels on a video display. Each reel comprises a plurality of symbols arranged in a predetermined sequence. Typically, when a reel stops, a plurality of symbols of each reel are visible on the display. For example, three symbols of each reel. While the stopping position of the reel can be chosen in a number of different ways, in all cases, the symbols which stop in the display are adjoining symbols in the symbol sequence. Typically, when spinning of the reels is simulated, symbols before the stopped symbols in the symbol sequence will be visible at least as the reel comes to a stop.

### SUMMARY OF THE INVENTION

Certain examples provide methods, systems, and apparatus for gaming and gaming controllers.

Certain examples provide a method of gaming. The example method includes determining a presence of a multiple element symbol combination in a player combination of symbols to be generated and displayed to a player at a gaming display. The method also includes randomly generating a first element of the multiple element symbol combination. The method further includes randomly generating a second element of the multiple element symbol combination, wherein the second element is different from the first element. Additionally, the method includes determining one or more game outcomes in the player combination of symbols, wherein each element of the multiple element symbol combination is evaluated for contribution to a winning pattern in the player combination of symbols enabling a plurality of different winning patterns including the multiple element symbol combination. The method includes outputting the player combination of symbols and an indication of the one or more game outcomes to the gaming display for player view.

Certain examples provide a gaming controller. The example gaming controller includes a symbol determinator providing a player combination of symbols based on one or more random numbers generated by a random number generator for selection of one or more symbols from a symbol library. The player combination of symbols includes a multiple element symbol. The random number generator randomly generates a first element of the multiple element symbol and randomly generates a second element of the multiple element symbol, wherein the second element is different from the first element. The gaming controller also includes a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination. The gaming controller further includes a display output outputting the player combination of symbols and an indication of the one or more game outcomes to the gaming display for player view.

Certain examples provide an article of manufacture including a computer readable medium and executable program instructions embodied in the computer readable storage medium that when executed by a programmable system cause the system to perform functions that implement a gaming controller. The example gaming controller thus implemented includes a symbol determinator providing a player combination of symbols based on one or more random numbers generated by a random number generator for selection of one or more symbols from a symbol library. The player combination of symbols includes a multiple element symbol. The random number generator randomly generates a first element of the multiple element symbol and randomly generates a second element of the multiple element symbol, wherein the second element is different from the first element. The gaming controller also includes a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination. The gaming controller further includes a display output outputting the player combination of symbols and an indication of the one or more game outcomes to the gaming display for player view.

Certain examples provide a gaming system. The example gaming system includes a player interface includes a display for viewing by a player. The gaming system also includes a gaming controller. The gaming system further includes a display output outputting the player combination of symbols and an indication of the one or more game outcomes to the gaming display for player view. The gaming controller includes a symbol determinator providing a player combination of symbols based on one or more random numbers generated by a random number generator for selection of one or more symbols from a symbol library. The player combination of symbols includes a multiple element symbol. The random number generator randomly generates a first element of the multiple element symbol and randomly generates a second element of the multiple element symbol, wherein the second element is different from the first element. The gaming controller also includes a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination. The gaming controller further includes a display output outputting the player combination of symbols and an indication of the one or more game outcomes to the gaming display for player view.

### BRIEF DESCRIPTION OF THE DRAWINGS

FIG. 1 is a block diagram of the core components of a gaming system.

FIG. 2 is a perspective view of a gaming machine.

FIG. 3 is a block diagram of the functional components of a gaming machine.

FIG. 4 is a block diagram representing the structure of a memory.

FIG. 5 is a diagram schematic of a networked gaming system.

FIG. 6 is a further block diagram of the gaming system.

FIG. 7 depicts an example matrix of symbol positions for a gaming system display.

FIG. 8 shows a logical representation of a gaming system.

FIGS. 9A and 9B depict example reel strips including single element and multiple element symbols.

FIGS. 10A and 10B depict example reel strips including single element and multiple element symbols.

FIG. 11 illustrates a block diagram for an example gaming system providing multiple symbols simultaneously in one or more symbol positions.

FIG. 12 depicts a flow diagram for an example method for generating multiple element symbols for game play.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, DVD, CD, etc. storing the software and/or firmware.

A game, such as a casino game, and one or more related systems and methods may be provided to generate enhanced reel strips (e.g., physical and/or virtual reel strips or patterns of symbols) including multiple element symbols or symbol combinations (e.g., Jack-Queen, Queen-King, etc.).

As an example, a gaming system is provided that implements a spinning reel game including a plurality of reels having a plurality of symbols in a designated symbol sequence. The gaming system has a game controller which implements a game in which one or more symbols are selected independent of the symbol sequence for display whereby the displayed symbols of each reel may be non-adjacent symbols. The display of spinning of the reels is controlled such that during at least part of the display of spinning, the reel is displayed as spinning in the symbol sequence relative to the display positions. In an example, this is achieved by displaying each selected symbol as stopping independently while the remainder of the reel is displayed as continuing to rotate. In one example, symbols are selected for each reel independent of the symbol sequence. In other examples, symbols may be selected independently for a subset of reels.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisioned. For example, an architecture may be provided wherein a gaming machine is networked with a gaming server and the respective functions of the gaming machine and the gaming server are selectively modifiable. For example, the gaming system may operate in stand alone gaming machine mode, “thick client” mode, or “thin client” mode depending on the game being played, operating conditions, etc. Other variations will be apparent to persons skilled in the art.

A gaming system may be any electronic gaming machine (EGM) such as a slot machine, fruit machine, video Poker machine, Keno or Bingo machine, or any other electronic gaming device or terminal including a handheld electronic device or an electromechanical stepper machine. A gaming system may also include a live table game such as Blackjack, Pai Gow, or Baccarat, a multi-terminal gaming machine such as multi-terminal roulette, Sik Bo, Poker, dice games, and others that may be interfaced with a player tracking module and slot accounting system. As an example, a gaming table layout may be embodied as a video display. Thus, a gaming system, as used herein, includes gaming tables as well, and is not limited to any specific kind of gaming device.

A gaming system could also be implemented in a personal digital assistant, cell phone, mobile gaming, or any other gaming environment where gaming takes place using monetary based wagers, e.g., casino gaming, or for novelty gaming using promotional or valueless credits. Further, where games are connected to or interact with a large screen display, the features may be applied to the individual gaming machines or the large display.

A gaming system can provide primary or main game(s) and secondary or bonus/feature games to a player. Games can be provided via preconfigured storage at the gaming system, via download from an external source, and/or via server-based execution, for example. Games can be provided in response to certain player and/or casino actions, including but not limited to player tracking rewards, game play, casino promotions, tournament play, etc. Gaming systems can provide player and/or game play data to a management system and/or external monitor for player tracking, auditing, slot accounting, regulatory/licensing compliance, and/or other purpose, for example.

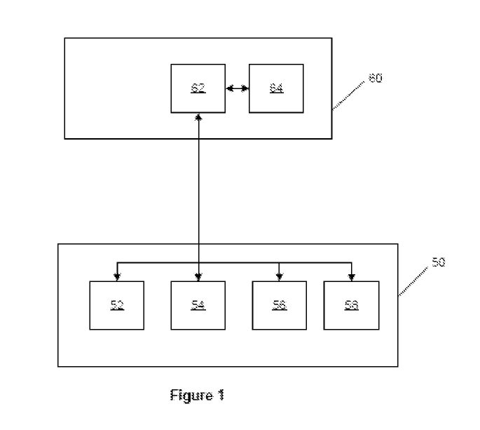

Irrespective of the form, the gaming system includes several core components. At the broadest level, the core components are a player interface 50 and a game controller 60 as illustrated in FIG. 1. The player interface 50 is arranged to enable manual interaction between a player and the gaming system and for this purpose includes the input/output components for the player to enter instructions and play the game.

Components of the player interface 50 may vary from embodiment to embodiment but will typically include a credit mechanism 52 to enable a player to input credits and receive payouts, one or more displays 54, a game play mechanism 56 that enables a player to input game play instructions, and a speaker 58.

The game controller 60 is in data communication with the player interface and typically includes a processor 62 that processes the game play instructions in accordance with game play rules and outputs game play outcomes to the display(s) 54. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g., a personal computer) or a server.

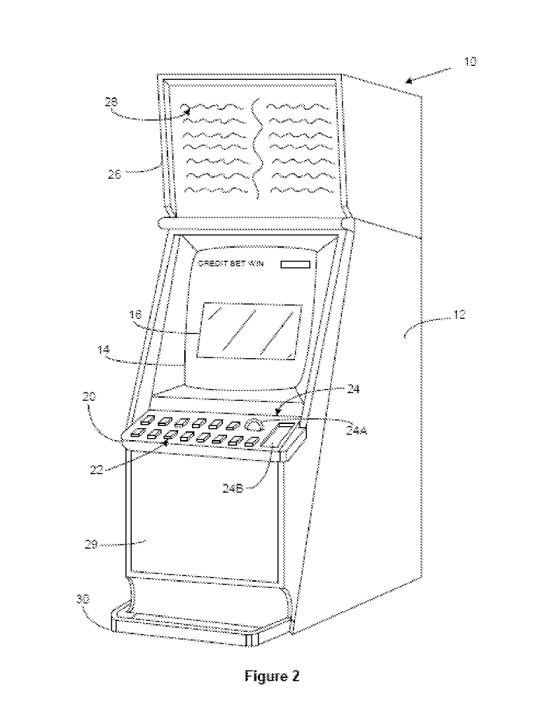

A gaming system in the form of a stand alone gaming machine 10 is illustrated in FIG. 2. The gaming machine 10 includes a console 12 having a video display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill/voucher acceptor 24B. Other credit input mechanisms may also be employed, for example, a card reader for reading a smart card, debit card or credit card. A player tracking module may be provided having a reading device for the purpose of reading a player tracking device, for example as part of a loyalty program. The player tracking device may be in the form of a card with a machine readable element such as a magnetic stripe, flash drive, and/or any other portable storage medium capable of being read by the reading device, for example.

A top box 26 may carry artwork 28, including, for example, pay tables and details of bonus awards and other information and/or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube (CRT) screen device. Alternatively, the display 14 may be a liquid crystal display (LCD), plasma screen, any other suitable video display unit. The top box 26 may also include a display, for example, a video display unit, which may be of the same type as the display 14, or of a different type.

The display 14 may include a game display area and a surrounding border or background, for example. Where a transmissive display is used, the transmissive display may overlay all or part of the game display area on the display 14. Video displays (e.g., LCD, CRT, plasma, etc.) and/or other illuminating or light sources (e.g., lamps, light emitting diodes (LEDs), etc.) may also be integrated with spinning reels to illuminate or animate desired display locations such as pay lines, pay combinations, winning lines, winning combinations, special symbols, etc.

Lighting may also be used to backlight symbols and/or generating a flickering or flashing effect as the electro-mechanical reels spin, for example. In certain embodiments, one or more light sources may be used with one or more filters to adjust certain characteristics of light emitted by the one or more light sources (e.g., altering lamp light to simulate natural daylight), for example.

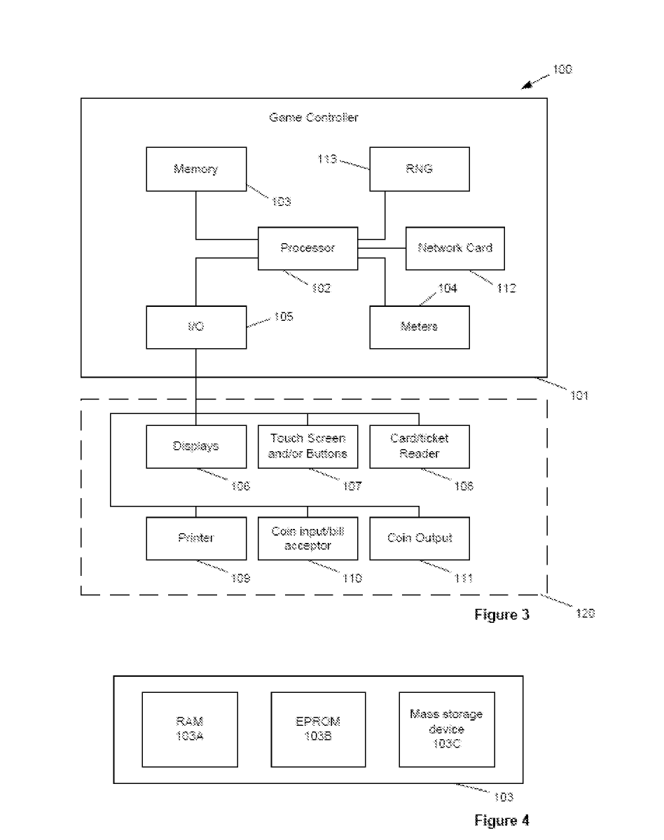

FIG. 3 shows a block diagram of operative components of a typical gaming machine which may be the same as or different to the gaming machine of FIG. 2. The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, and an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted depending on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, such as, for example, providing input/output devices 106, 107, 108, 109, 110, 111 remotely from the game controller 101.

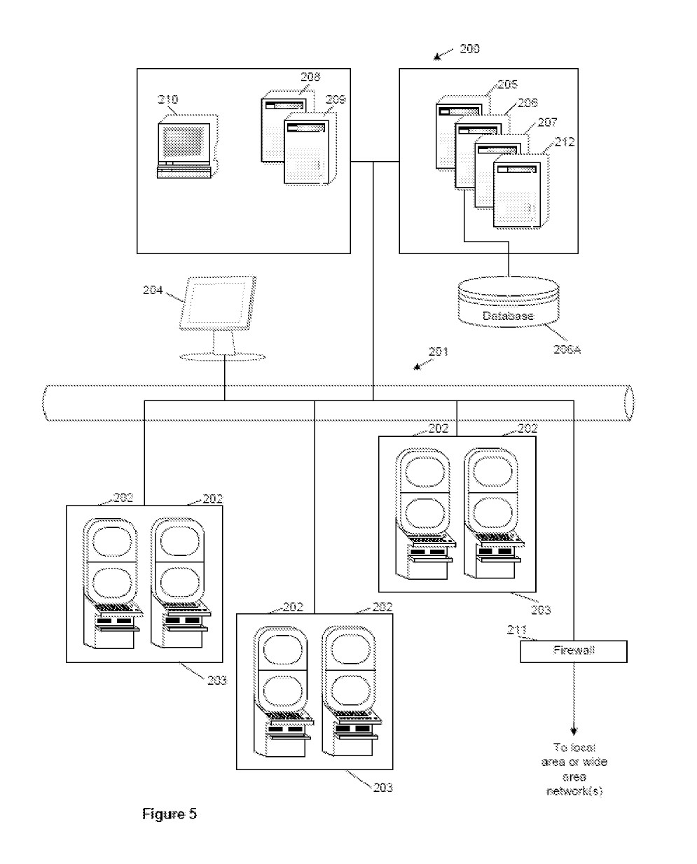

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisioned.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example, promotional or informational material.

In a thick client embodiment, game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming machines 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

An embodiment provides a spinning reel type game. Spinning reel type games typically allow a player to select how many pay lines of a plurality of pay lines they will play in each game—i.e. a minimum of one pay line up to the maximum number of pay lines allowed by the game. Persons, skilled in the art, will appreciate that in other embodiments, the player may select a number of reels to play. In most games, each pay line is formed by a set of symbol positions consisting of one symbol position from each reel. That is, a symbol position within the display which corresponds to a reel is assigned to a selected pay line. The symbol positions that constitute each of the pay lines are usually advertised to the player by markings on the display or diagrams showing the symbol positions that correspond to each offered pay line. Some of the pay lines will be horizontal or diagonal lines but others may be other combinations of symbols. Typically, the pay lines will be constituted by symbol positions in the visible window. A game outcome is determined based on the symbols on each wagered upon, e.g. bought, pay line and a prize table that specifies awards. Many modern games have five reels and three symbols of each reel are displayed when the reels stop defining a 3×5 matrix of displayed symbols. It should be understood that based upon the layout of the game reels “symbols” can include graphic representations such as cherries, 7s or other graphic designs or may include “blanks” which are the absence of graphical designs on the reel. The number of reels and a number of symbols or reel stops on each reel may vary (e.g., three reels, four reels, six reels, four symbols per reel, five symbols per reel, etc.) defining different matrices.

In prior art implementations, the game controllers of such gaming machines select symbols by employing a stop determining function that randomly determines the stop position for each reel. For example, if there are five reels, each having twenty-two symbols, the stop determining function might determine that the stop positions are positions: 3, 13, 7, 9 and 17 for reels one through five. The spinning of the reels is then controlled so that each symbol designated by the stop position comes to a stop in the same row, typically a predetermined row in a “window” visible to the player on the display that corresponds to a player playing a single win line—e.g. the middle horizontal row. The other symbols that are visible in the display will be adjacent symbols in the symbol sequence—e.g. if the determined stop position is 3, then the symbols allocated to positions 2 and 4 (above and below the stop position 3) will also be visible if three symbols of each reel are displayed.

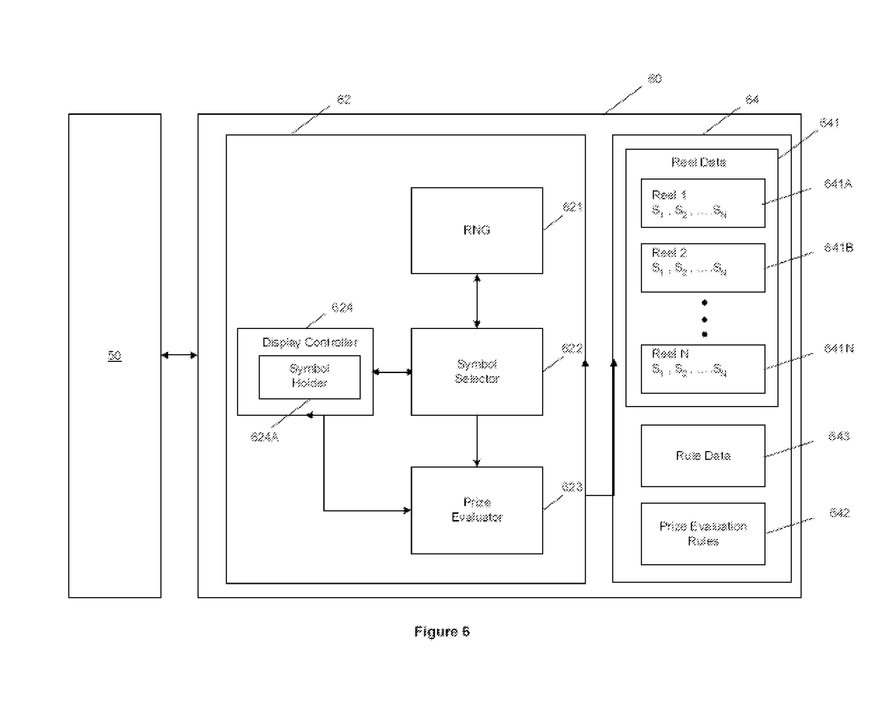

The game controller 60 of the embodiment is shown in more detail in FIG. 6. It will be apparent that the processor 62 implements a number of modules, for example random number generator module 621 by executing software routines. Persons skilled in the art will appreciate that not all modules need be implemented by processor 62. For example, the random number generator module 621 could be implemented by a separate circuit or by a random number generator server.

Referring to FIG. 6, in the embodiment, the symbol selector 622 is arranged to select a plurality of symbols for each reel independently of the symbol order S₁ to S_{N} specified in the reel data of each reel, reel 1 to reel N 641a, 641b, 641n. For example, each reel defines a physical reel strip (for electromechanical reels) and a virtual reel strip for video reels having symbols laid out, in order, S₁ to S_{N}, The symbol selector 622 sends data which indicates the order in which the symbols of each reel were selected to the display controller 624. The display controller 624 controls display of spinning and stopping of the symbols of each reel. Accordingly, it includes a symbol holder function 624a which is arranged to control the display 54 for spinning and stopping of the symbols.

One example implementation includes five reels and three display positions for each reel as indicated by a 3×5 matrix of display positions. Accordingly, in an example where a reel contains symbols from S₁ to S₃₀, i.e. S₁ is the first symbol position, S₃₀ is the last and any other symbol in between such as S₁₀ represents the 10^{th} position in that reel strip. This reel is to spin within a reel column size displaying three symbols, one for each row.

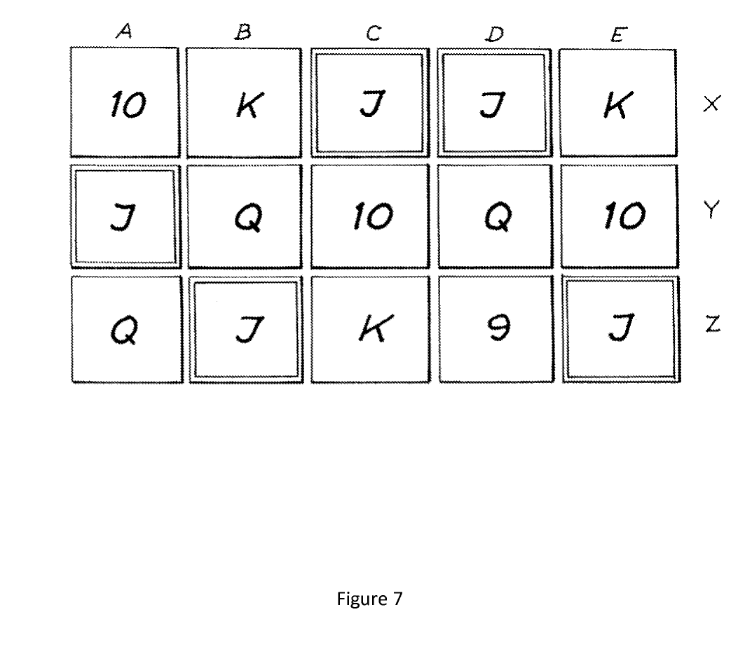

FIG. 7 depicts an example 5×3 matrix of symbol or reel display positions. Referring to the symbol positions by their matrix row and column designations (e.g., AX for the top left hand corner and EZ for the bottom right hand corner), it is noted that a top row includes symbol positions AX, BX, CX, DX, and EX. A bottom row includes symbol positions AZ, BZ, CZ, DZ, and EZ. Symbols may randomly, pseudo-randomly, and/or otherwise appears in the symbol positions of the displayed 3×5 matrix of FIG. 7. Symbols may appear as simulated spinning and stopping reels on a video or other graphical display, for example. Symbols may be represented on electro-mechanical spinning reels (e.g., stepper reels) with or without a graphical overlay, for example.

To operate a gaming system, a provision is made for a player to enter a wager (money wager, wager of accumulated credits, etc.) and select symbol arrangements (pay lines or reels) upon which to wager and for prompting the gaming system to generate and display an outcome at a content display. If the outcome on any wagered upon arrangement is a winning outcome, the player is awarded credits, coins, tokens, vouchers, etc. If the outcome is a losing outcome the player receives no award. A winning outcome may be embodied as one, two or more symbols in the display (i.e. scatter awards) or may be embodied as predetermined combinations of symbols appearing in a wagered upon, e.g. bought up, symbol arrangement such as on an enabled (wagered upon) pay line.

The outcome may be determined, for example, by the combination of symbols which appear in the display matrix. Each of the displayed five spinning reels displays a plurality of symbols, and when stopped presents one or more symbols in the display. The symbols displayed may be associated with pay lines and/or may represent “scatter” wins (a predetermined number of symbols displayed anywhere in the game display), for example. Five symbols may appear along each horizontal “line” or row of the display. For example, the middle row may be the row wagered upon and upon which the outcome is determined. The top row and the bottom row also have symbols and form two other pay line combinations of five symbols, which may be used to determine wins. Thus, a three-by-five matrix defining an array symbols appears as the content display.

Traditionally, pay lines are established for horizontal rows in the display matrix. However, modern games with up to fifty pay lines have been disclosed in U.S. Pat. No. 5,580,053 issued Dec. 3, 1996, to Crouch.

Game symbols are selected and displayed from a predetermined universe of symbols as set by the game designer. These symbols may be symbols which are common to numerous games as well as symbols which are unique to the individual game and reflect the overall theme of the game. As such, the symbols can have various shapes and colors or combinations of colors. For example, a symbol may be a brown horse with a red saddle, a bald eagle having the colors of white and grey, a human figure having flesh tones and blue clothing and so forth. Thus each symbol has a shape and a color (or multi-color) characteristic. In the display of a game outcome (or partial outcome) with a 5×3 matrix, as shown in FIG. 7, there would be a display of fifteen symbols, some of which may appear only once in the display and some which may appear multiple times in the display.

In a multi-reel, video slot machine there may be more than twenty different symbols in the universe of game symbols. These symbols or symbol combinations are randomly selected by known means such as an approved random number generator (RNG) for display on the five reels.

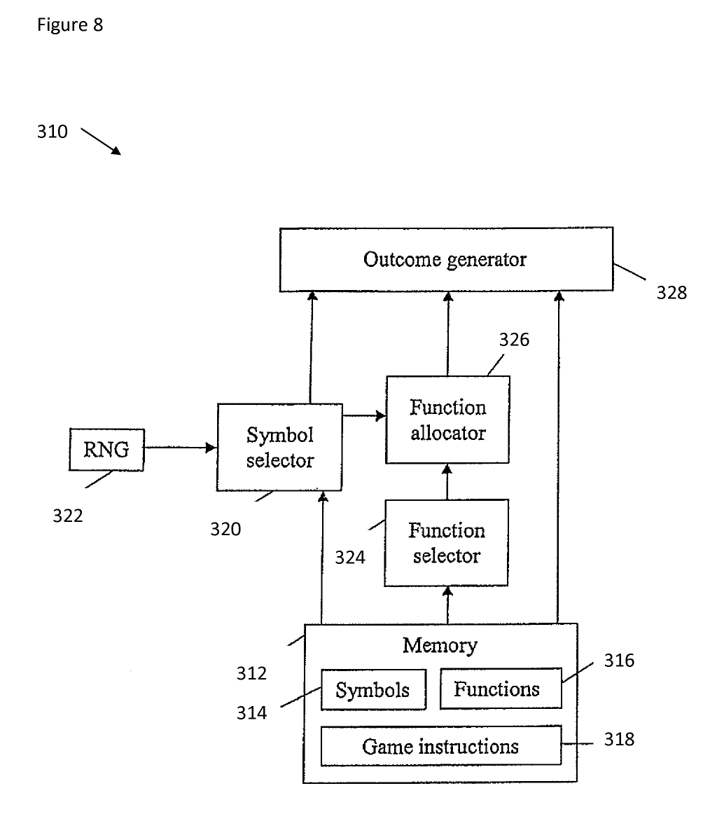

FIG. 8 shows a logical representation of a gaming system 310 arranged to implement a probabilistic game of the type wherein several symbols from a set of symbols are randomly displayed and a game outcome is determined on the basis of the displayed symbols. With some such probabilistic games, the set of symbols include standard symbols at least one of which is a function symbol, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

The gaming system 310 operates such that one or more function symbols can effectively be added during a game so as to modify the probability of occurrence of a win outcome and thereby enhance player interest in playing the game. This is achieved by selecting one or more symbols to acquire a new function and determining game outcomes based on displayed symbols and the new function. The function acquired by a symbol may be in place of or in addition to any function already associated with the symbol.

Referring to FIG. 8, the gaming system 310 comprises a memory 312 arranged to store symbol data 314 indicative of a plurality of symbols for subsequent display to a player, function data 316 indicative of one or more functions allocatable to the symbols, and game instruction data 318 indicative of game instructions usable by the gaming machine 310 to control operation of the game.

The gaming system 310 also includes a symbol selector 320 which is arranged to select several symbols for display to a player and in some game circumstances to select one or more symbol to which a function is to be allocated. In this example, the selection carried out by the symbol selector 320 is made using a random number generator 322.

It will be appreciated that the random number generator 322 may be of a type which is arranged to generate pseudo random numbers based on a seed number, and that in this specification the term “random” will be understood accordingly to mean truly random or pseudo random.

The gaming system 310 also comprises a function selector 324 arranged to select one or more functions for allocation to one or more symbols selected during the special game circumstances, and a function allocator 326 arranged to allocate the or each function selected by the function selector 324 to one or more symbols selected during the special game circumstances. The function selector 324 may be arranged to randomly select a function or to select a function on the basis of a predefined rule.

The gaming system 310 also comprises an outcome generator 328 which in accordance with the game instructions 318 determines game outcomes based on the symbols selected for display to a player by the symbol selector 320, and on the basis of the function(s) allocated to one or more selected symbols, if any.

In the embodiments described below, the symbol selector 320, the function selector 324, the function allocator 326, and the outcome generator 328 are at least partly implemented using a microprocessor, although it will be understood that other implementations are envisioned.

The gaming system 310 can take a number of different forms, as described above.

Persons skilled in the art will appreciate that in some examples the player may operate a touch screen and/or buttons 107 to facilitate game play, for example.

In certain example embodiments, multiple symbols can be represented in a single reel stop or position, for example. In some examples, multiple symbols can be generated independently for a single reel position. In other examples, a multiple-element symbol can be generated as a combined unit for a reel position. In some examples, certain symbol positions are eligible for multiple symbols. In other examples, all positions are eligible for multiple symbols.

In certain examples, mechanical reel slot machines are limited in that the physical reel strips have a certain number of symbol stops on each reel, such as twenty to twenty-two reel stops. One game design limitation of a physical reel strip is that combinations of multiple simultaneous pays can only have a few permutations compared to long virtual video strips with many more symbol positions available. By putting two different symbols on one reel stop, multiple pays on different lines can occur, thus increasing the potential volatility of the game, for example. In certain embodiments, mechanical reel strips, as well as virtual video reels, can be equipped with multi-symbol reel stops.

Rather than simply duplicating a determined symbol to extend a single payout combination, as discussed in U.S. Patent Application Publication No. 20040058727, certain examples described herein provide chances for multiple symbols and multiple pays. The replicated symbol in U.S. Patent Application Publication No. 20040058727 adds to the determined payout for the same pay, as shown in FIGS. 3A and 3B, rather than provide the possibility of multiple winning combinations via the single reel stop. Certain examples randomly combine two or more different symbols in a reel stop.

Certain examples can provide multiple pays to a player with a single reel stop having multiple symbols. Multiple pays can include multiple standard line pays, multiple reel power pays, etc. Multiple symbols and multiple pays can be applied in a base game, such as a slot machine, video poker, and/or other base game, a bonus game, and/or other feature of a gaming device, for example. The gaming device can include an electromechanical stepper, video slot/poker machine, transmissive/transparent reel device, etc.

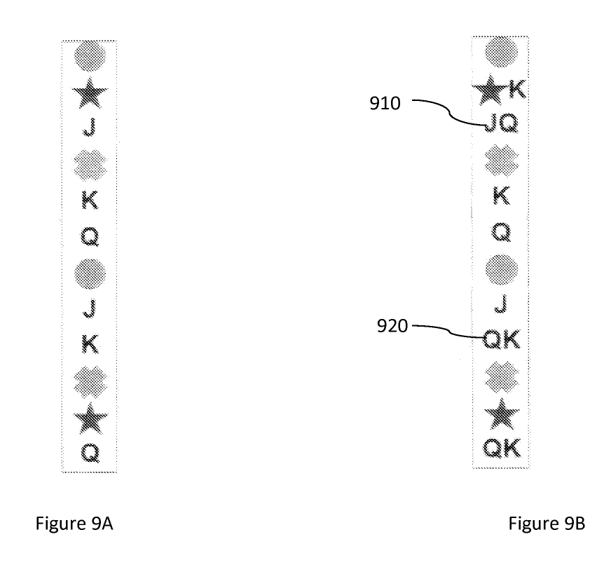

FIG. 9A depicts an example reel strip having five symbols distributed over twelve reel stops. FIG. 9B shows that, by doubling up some of the symbols, there are now sixteen symbols rather than twelve within the same twelve reel stops. For example, as shown in FIG. 9B, a multiple element symbol 910 indicating JQ (e.g., a Jack and a Queen) can be handled by game processing logic as a wild symbol for both Jacks and Queens. FIG. 9A illustrates, for comparison, a reel strip only including single element symbols. When the logic is looking for symbol combinations to determining winning outcomes, the logic looks at both Jacks and wilds, for example. Each combination symbol can be added into a total symbol list and assigned a certain relevance. Alternatively and/or in addition, a large array of all possible reel combinations can be generated. Certain examples can use the list and/or array for a random determination of a number of multiple symbols and at which reel stops the multiple symbol(s) are found. For example, JQ 910, QK 920, etc., can be used as wild symbols or the like and have a random probability of “spinning up.” In a video reel system, a single symbol can be modified or changed to become a multiple symbol. As discussed above, multiple element symbols 910, 920 can be provided for random selection along with single element symbols K, Q, J, etc. Alternatively or in addition, elements within a multiple element symbol combination can each by dynamically determined. Thus, in certain examples, a displayed matrix of symbols can include 1) combined symbol JQ in addition to separate symbols J and Q or 2) a determination that there will be two symbols and then individual determinations of what those two symbols will be (e.g., J combined with Q).

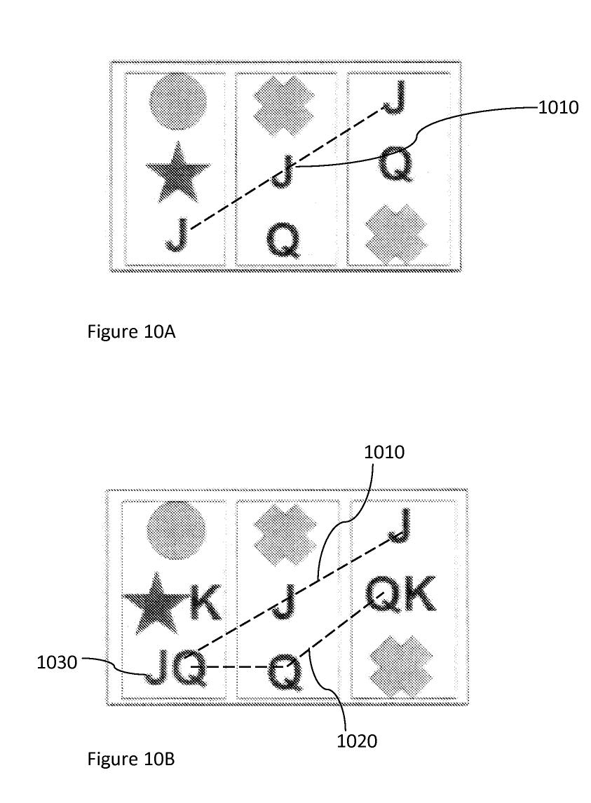

As shown in FIG. 10A, a typical game result may have one win. A diagonal of three Jack symbols 1010 pays, but no other lines pay. With doubled symbols, the same reel stops can have multiple wins. As shown in FIG. 10B, the presence of three Jack symbols 1020 pays out for the player, and the presence of three Queen symbols 1030 pays for the player, both combinations sharing the JQ (Jack, Queen) symbol 1040.

As discussed above, single and/or multiple element symbols can be randomly (or pseudorandomly) generated according to any of a number of available techniques, for example. For example, one technique is to select the symbols at random from a set of available symbols sorted in memory 103. Symbols can be selected using any of a variety of known techniques for selecting symbols for a spinning reel type game, for example. Other techniques can be used to control the odds of particular outcomes occurring to thereby control a return to the player of the game. For example, it is known to randomly determine the outcome and then map the outcome to a symbol combination.

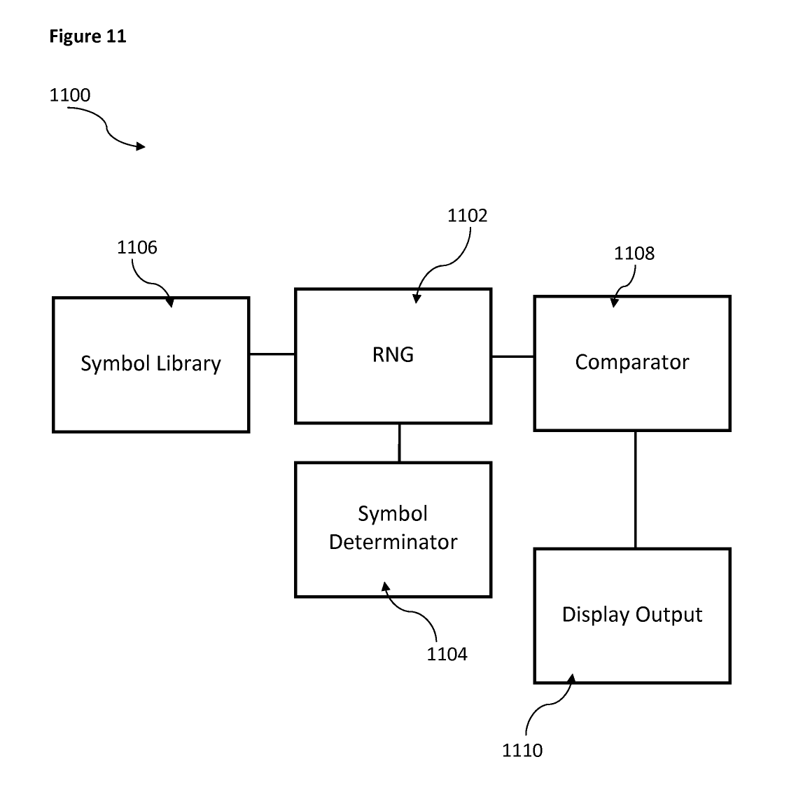

FIG. 11 illustrates a block diagram for an example gaming system 1100 providing multiple symbols simultaneously in one or more symbol positions. The system 1100 includes a random number generator (RNG) 1102, a symbol determinator 1104, a symbol library 1106, a comparator 1108, and a display output 1110. The components of the system 1100 can be implemented in hardware, software, and/or firmware separately and/or in various combinations, for example.

The RNG 1102 generates one or more symbols for display in a pattern or matrix (e.g., a 3×5 or 4×4 matrix) using the symbol library 1106. Symbols from the symbol library 1106 can be assigned a number and/or range of numbers for selected by the RNG 1102 for example. In certain examples, the symbol library 1106 includes single element symbols and multiple element symbols for selection based on RNG 1102 output. In certain examples, the symbol library 1106 includes single element symbols for selection based on RNG 1102 output.

In certain examples, the symbol determinator 1104 determines whether symbol/reel positions will include single element symbols or multiple element symbols. If the symbol determinator 1104 determines (e.g., randomly) that a position should include a multiple-element symbol position, the symbol determinator 1104 requests multiple numbers from the RNG 1102 to select multiple symbols from the symbol library 1106 to display multiple elements or symbols at a single position.

The comparator 1108 examines the symbols provided from the symbol library 1106 based on RNG 1102 output and compares the symbols to a paytable, rules, etc. determine an outcome. Outcomes may vary depending upon game parameters and/or rules, for example (e.g., base game, feature game, tournament mode, etc.). In certain examples, if a multiple element symbol is found at a symbol/reel position, the comparator 1108 evaluates each of the component symbols in the multi-element symbol to determine player outcome(s).

The comparator 1108 result helps to form the display output 1110, which utilizes a graphic display driver to cause symbols to be displayed on a screen, such as a primary or secondary display on a gaming machine. Symbols can be moved in sequence downwardly in the reels, for example, to provide an appearance of spinning reels which are then stopped. The display output 1110 can be provided on, for example, electromechanical reels, an overlay over electromechanical reels, a video display simulating reels, a video display providing a matrix of symbol positions such as a 3×5, 5×5, 4×4, etc. matrix of symbols positions. In certain embodiments, a player can employ an interface device such as a handle, button(s), and/or a touch screen, to initiate game play, stop reel spins, and/or otherwise interact with the displayed game. A player can use the interface device, for example, to select win lines or pay lines in the game display.

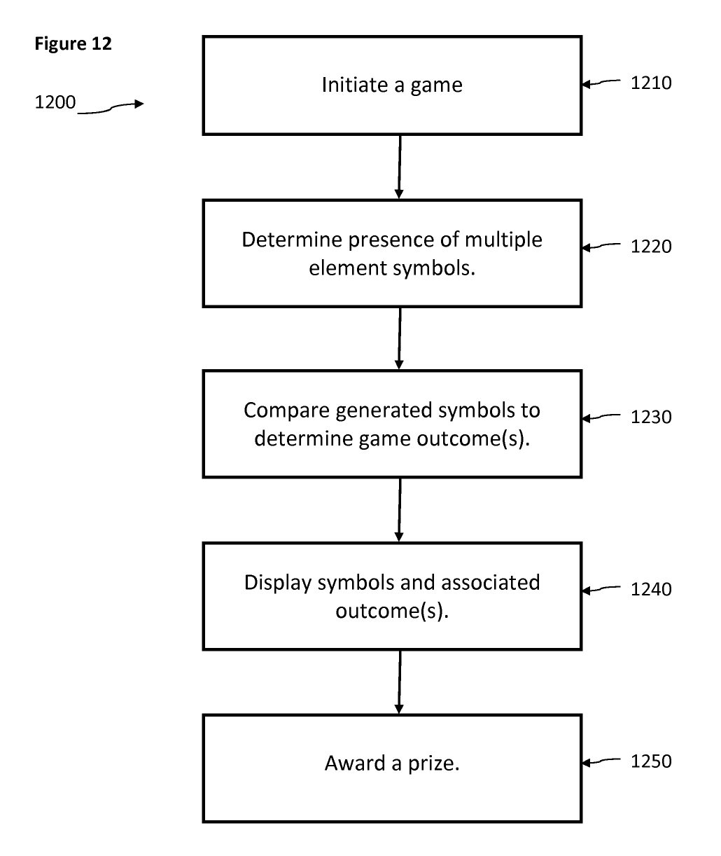

FIG. 12 depicts a flow diagram for an example method 1200 for generating multiple element symbols for game play.

At 1210, a game is initiated. The game can be a spinning reel game occurring on a 5×3 video matrix, for example. The game can be initiated by a triggering event, such as a button press, a touch screen push, a handle pull, etc. A wager may be required to initiate game play, for example.

At 1220, presence of multiple element symbols is determined. In some examples, multiple element symbols are selected the same as single element symbols using a random number generator and/or other outcome-determination method and/or device to determine values for one or more symbols to be displayed. In other examples, the presence of multiple element symbols is determined (e.g., randomly and/or influenced by other game events), and then symbols are selected from a symbol library based on random number generation. For single element symbols, only one symbol is selected from the symbol library based on a random number outcome. For multiple element symbols, multiple symbols are selected from the symbol library based on one or more random number outcomes. In some examples, a random number outcome can be used to determine how many multiple symbols are present (e.g., two, three, etc.).

At 1230, the generated symbols are compared to one or more rules to determine game outcome(s). For example, selected symbol(s) in the player's combination are compared to a paytable and/or other set of rules/symbol patterns to determine whether a prize is to be awarded, such as one or more free games, credits, bonus games, features, promotions, etc.

At 1240, the symbols and associated outcome(s) are displayed. For example, the matrix or pattern of symbols, including single element and/or multiple element symbols, is displayed via a liquid crystal display on an electronic gaming machine to one or more participating players. As another example, generated symbols and outcome(s) can be provided on electromechanical reels with or without transparent and/or translucent overlay.

At 1250, a prize is awarded, if applicable, to the player. That is, if one or more of the outcomes provide a winning combination to the player, a prize is awarded to the player. The prize can include money, credit, a voucher, food, transportation, lodging, entertainment, a bonus game, etc. The prize from the cooperative reels can be in conjunction with another base game and/or bonus prize, for example.

One or more components of the method 1200 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these components and/or perform the components in a different order than the order listed. For example, some components may not be performed in certain examples. As a further example, certain components may be performed in a different temporal order, including simultaneously, than listed above.

Other variations would be apparent to persons skilled in the art and should be considered as falling within the scope of the invention described herein. In particular, further embodiments can be formed from the features described above.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

It is to be understood that, if any prior art publication is referred to herein, such reference does not constitute an admission that the publication forms a part of the common general knowledge in the art, in Australia or any other country.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Method steps associated with certain embodiments may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A method of gaming implemented on a gaming machine, the method comprising:
determining a presence of a multiple element symbol combination in a player combination of symbols to be generated and displayed to a player at a gaming display;
randomly generating a first element of the multiple element symbol combination;
randomly generating a second element of the multiple element symbol combination, wherein the second element is different from the first element;
determining one or more game outcomes in the player combination of symbols, wherein each element of the multiple element symbol combination is evaluated for contribution to a winning pattern in the player combination of symbols enabling a plurality of different winning patterns including the multiple element symbol combination; and
outputting the player combination of symbols and an indication of the one or more game outcomes to the gaming display for player view.

2. A method as recited in claim 1, wherein the player combination of symbols is generated as part of a reel-based symbol game.

3. A method as recited in claim 2, wherein the reel-based symbol game comprises electromechanical reels viewable via the gaming display.

4. A method as recited in claim 2, wherein the reel-based symbol game comprises virtual reels displayed on the gaming display.

5. A method as recited in claim 1, further comprising awarding a prize to the player based on the one or more game outcomes.

6. A method as recited in claim 1, wherein the randomly generating the first element and the randomly generating the second element are performed jointly to generate the multiple element symbol combination which is treated as a wild symbol for a type of symbol corresponding to each of the first element and the second element when evaluating the multiple element symbol combination for contribution to a winning pattern in the player combination of symbols.

7. A gaming controller comprising:
a symbol determinator providing a player combination of symbols based on one or more random numbers generated by a random number generator for selection of one or more symbols from a symbol library, the player combination of symbols including a multiple element symbol, wherein the random number generator randomly generates a first element of the multiple element symbol and randomly generates a second element of the multiple element symbol, wherein the second element is different from the first element;
a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination; and
a display output outputting the player combination of symbols and an indication of the one or more game outcomes to the gaming display for player view.

8. A gaming controller as recited in claim 7, wherein the player combination of symbols is generated as part of a reel-based symbol game.

9. A gaming controller as recited in claim 8, wherein the reel-based symbol game comprises electromechanical reels viewable via the gaming display.

10. A gaming controller as recited in claim 8, wherein the reel-based symbol game comprises virtual reels displayed on the gaming display.

11. A gaming controller as recited in claim 7, further comprising awarding a prize to the player based on the one or more game outcomes.

12. A gaming controller as recited in claim 7, wherein the randomly generating the first element and the randomly generating the second element are performed jointly to generate the multiple element symbol combination which is treated as a wild symbol for a type of symbol corresponding to each of the first element and the second element when evaluating the multiple element symbol combination for contribution to a winning pattern in the player combination of symbols.

13. An article of manufacture comprising:
a computer readable storage medium; and
executable program instructions embodied in the computer readable storage medium that when executed by a programmable system cause the system to perform functions that implement a gaming controller comprising:
a symbol determinator providing a player combination of symbols based on one or more random numbers generated by a random number generator for selection of one or more symbols from a symbol library, the player combination of symbols including a multiple element symbol, wherein the random number generator randomly generates a first element of the multiple element symbol and randomly generates a second element of the multiple element symbol, wherein the second element is different from the first element;
a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination; and
a display output outputting the player combination of symbols and an indication of the one or more game outcomes to the gaming display for player view.

14. An article of manufacture as recited in claim 13, wherein the player combination of symbols is generated as part of a reel-based symbol game.

15. An article of manufacture as recited in claim 14, wherein the reel-based symbol game comprises electromechanical reels viewable via the gaming display.

16. An article of manufacture as recited in claim 14, wherein the reel-based symbol game comprises virtual reels displayed on the gaming display.

17. An article of manufacture as recited in claim 13, further comprising awarding a prize to the player based on the one or more game outcomes.

18. An article of manufacture as recited in claim 13, wherein the randomly generating the first element and the randomly generating the second element are performed jointly to generate the multiple element symbol combination which is treated as a wild symbol for a type of symbol corresponding to each of the first element and the second element when evaluating the multiple element symbol combination for contribution to a winning pattern in the player combination of symbols.

19. A gaming system comprising:
a player interface comprising a display for viewing by a player;
a game controller arranged to:
a symbol determinator providing a player combination of symbols based on one or more random numbers generated by a random number generator for selection of one or more symbols from a symbol library, the player combination of symbols including a multiple element symbol, wherein the random number generator randomly generates a first element of the multiple element symbol and randomly generates a second element of the multiple element symbol, wherein the second element is different from the first element;
a comparator determining one or more game outcomes in the player combination of symbols, wherein each element of the multiple element symbol combination is evaluated for contribution to a winning pattern in the player combination of symbols enabling a plurality of different winning patterns including the multiple element symbol combination; and
a display output outputting the player combination of symbols and an indication of the one or more game outcomes to the gaming display for player view.

20. A gaming system as recited in claim 19, wherein the player combination of symbols is generated as part of a reel-based symbol game.

21. A gaming system as recited in claim 20, wherein the reel-based symbol game comprises electromechanical reels viewable via the gaming display.

22. A gaming system as recited in claim 20, wherein the reel-based symbol game comprises virtual reels displayed on the gaming display.

23. A gaming system as recited in claim 19, further comprising awarding a prize to the player based on the one or more game outcomes.

24. A gaming system as recited in claim 19, wherein the randomly generating the first element and the randomly generating the second element are performed jointly to generate the multiple element symbol combination which is treated as a wild symbol for a type of symbol corresponding to each of the first element and the second element when evaluating the multiple element symbol combination for contribution to a winning pattern in the player combination of symbols.

25. A gaming system as recited in claim 19, wherein the player interface comprises at least one of a set of electromechanical reels, a video display, and an overlay with respect to a set electromechanical reels.
